(19) United States
(12) Patent Application Publication
(10) Pub. No.: US 2026/0160133 A1
(43) Pub. Date: Jun. 11, 2026

(54) DRILL BIT STEERING SYSTEM

(71) Applicant: Baker Hughes Oilfield Operations LLC, HOUSTON, TX (US)

(72) Inventors: Behrend BODE, Hannover (DE); Volker PETERS, Hannover (DE); Bastian SAUTHOFF, Hannover (DE)

(73) Assignee: Baker Hughes Oilfield Operations LLC, HOUSTON, TX (US)

(21) Appl. No.: 19/410,913

(22) Filed: Dec. 5, 2025

Related U.S. Application Data
(60) Provisional application No. 63/728,561, filed on Dec. 5, 2024.
(60) Provisional application No. 63/728,551, filed on Dec. 5, 2024.
(60) Provisional application No. 63/728,557, filed on Dec. 5, 2024.

(51) Int. Cl. E21B 7/04

(52) U.S. Cl. CPC E21B 7/04

(57) ABSTRACT

A drilling system having a drill string and a bottom hole assembly (“BHA”) is used to drill a wellbore in a subterranean formation. The BHA includes a drill bit and a steering arm for steering the drill bit through the subterranean formation. The steering arm is part of a steering assembly that operates in response to a pressure difference in drilling mud flowing through the BHA. The pressure difference is selectively created by controlling the flow of drilling mud through a pair of channels in the BHA. The steering arm is coupled with a piston having opposing sides in communication with the channels. Regulating how much flow passes through each of the channels creates a pressure difference across the piston to generate a force. The force is used to pivot the steering arm outward against the wellbore wall to steer the drill bit.

### CROSS REFERENCE TO RELATED APPLICATION

This application claims priority to and the benefit of U.S. Provisional Application Ser. No. 63/728,561 filed on Dec. 5, 2024, entitled “Force Balanced Dual Valve Pulser System”, U.S. Provisional Application Ser. No. 63/728,551 filed on Dec. 5, 2024, entitled “Mud Hydraulic Operated Rotary Steerable System”, and U.S. Provisional Application Ser. No. 63/728,557 filed on Dec. 5, 2024, entitled “Combined Rotary Steerable and Mud Pulse Telemetry Tool”, which are incorporated by reference herein in their entireties and for all purposes.

### BACKGROUND OF THE INVENTION

### 1. Field of Invention

The present disclosure relates to steering a drilling system while forming a wellbore.

### 2. Description of Prior Art

Drilling systems with earth boring drill bits on ends of drill strings are commonly used in the oil and gas industry for drilling wellbores into hydrocarbon bearing geologic formations. In many drilling system the drill bit is part of a bottom hole assembly (“BHA”) that is connected to a lower end of the drill string. Some drilling systems include a rotary or top drive coupled with a drilling rig on the surface, which rotate the drill string and attached BHA for boring through the subterranean formation. In other varieties of drilling systems, included in the BHA is a downhole drive that rotates the drill bit with respect to the drill string. A mud motor is one type of a downhole drive that harvests energy from a drilling fluid or mud flowing through the drill string for rotating the drill bit, the entire or parts of the BHA together with the drill bit.

During rotary drilling operations, the drilling mud is pumped from the surface down the drill string through the BHA and the drill bit into an annulus between the drill string and the wellbore wall. The mud then returns to the surface in an annulus between walls of the wellbore and drill string, cuttings from the formation are carried uphole with the returning mud flow. While wellbores are often vertically straight at lesser depths, but in order to reach a target destination, at greater depths many wellbores include curves or have different orientations, e.g., deviated or horizontal portions. To create a curved or different orientation wellbore, a drilling operator often uses a steering assembly to steer the drill bit during drilling. Steering assemblies employ a valve in a BHA along with a cylinder and piston assembly configured to actuate a pad. The assembly and pad are generally placed near or adjacent the drill bit, when actuated the pad pushes against the wellbore wall to change the drill bit direction and form the wellbore having a designated configuration.

Prior art systems utilize mud hydraulic systems operating with a portion of the drilling mud flow while guiding the main portion of the flow towards the drill bit and bit nozzles. The pad and piston actuation system therefore operates with a smaller fraction (typically below 10%) of the mud flow and a bypass channel. A valve is operated to guide the drilling mud into cylinder and piston devices to actuate the pads/pistons against the borehole formation. After actuation the piston retracts and discharges the drilling mud into the annulus. Operating prior art mud hydraulic activated devices pose several challenges: The bypass flow requires filter screens to prevent larger debris and particles from entering the valve, cylinder, piston and discharge components; Filter, valve, flow channels and discharge components may get blocked by sediments, particles or lost circulation materials (LCM). Blocked and/or plugged hydraulics may cause inability to steer; Discharge through a relief channel and/or sealing gap can cause erosion; Discharge through the relief channel and/or sealing gap is enforced by activation of an opposite pad/piston which causes a reduction of steer force; The hydraulics depend on pre-selected (tool and bit) nozzles as well as flow rate and density of the mud flow, restricting operating parameters. Steer forces cannot be adjusted for a given flow density and pre-set choice of nozzles; and proportional steering, which uses adjustable force vectors according to the demanded force and direction, is not possible

Prior art steering systems typically use piston/cylinder assemblies that are positioned at an outside housing and which are either in direct contact with the borehole wall or underneath a steering arm that is pinned end pivotingly coupled to the housing. Considering the limited differential pressure between an inside channel and the annulus and in order to provide sufficient force for the steering function, such piston devices have to be designed with a certain minimum diameter. Generally, the larger the diameter of the steering piston, the better. Those preferably large piston/cylinder devices require large openings through the sidewall of the collar. Considering allowable stresses at the expected load scenario from downhole drilling, large openings pose a conflict, designers have to resolve.

### SUMMARY OF THE INVENTION

Disclosed herein is an example method of wellbore operations that includes forming a wellbore in a subterranean formation with a drill string that comprises a drill bit on an end of a pipe string, directing a flow of drilling fluid through a bore in the pipe string, splitting the flow into first and second streams having different pressures, selectively converting the different pressures into a force, and steering the drill bit through the formation by applying the force between the drill bit and a sidewall of the wellbore. In an alternative, the first stream is directed into a first chamber and the second stream is directed into a second chamber, where a fluid flow barrier is between the first and second chambers that includes a piston moveably disposed in a cylinder, and where the piston moves radially with respect to an axis of the drill string in a direction away from the stream having the greater pressure. In one embodiment, the force is exerted to the sidewall by a steering arm that is on an outer surface of the drill string, the steering arm pivoting outward from the drill string into steering contact with a sidewall of the wellbore in response to radial movement of the piston, and optionally the steering arm has a pinned end pivotingly coupled to the drill string, a free end distal from the pinned end, and extends along a portion of a circumference of the drill string between the free end and the pinned end. Further optionally, the force is transferred from the piston to the steering arm by a rod, the rod having a terminal end in sliding contact with a lateral surface of the free end that faces an outer surface of the drill string. A valve system is alternatively used to split the flow into first and second streams and at different pressures. In one embodiment, the steering arm is a first steering arm and the valve system, piston, rod, and first steering arm form a steering system, which has a second steering arm, and where the second steering arm has a pinned end pivotingly coupled to the drill string, a free end distal from the pinned end, and extends along a portion of a circumference of the drill string between the free end and the pinned end. This alternative further includes steering the drill bit in a different direction by reversing relative pressures in the streams so that the second steering arm is pivoted radially outward from the drill string. The method further optionally includes forming complementary curved contact surfaces between the rod and the steering arms to reduce friction between the rod and the steering arms.

Also disclosed is an example of a drilling system for excavating a wellbore, which includes a rotational drive unit, a drill string coupled with the rotational drive unit and that is rotatable in response to operation of the rotational drive unit. The drill string includes a pipe string made from lengths of drill pipe connected to one another end to end and having an axial bore that selectively contains a flow of drilling fluid, a drill bit coupled to an end of the pipe string, and a steering system that includes chambers in a path of the flow of drilling fluid configured to receive a portion of the flow of drilling fluid that is selectively at a pressure different from another portion of the flow of drilling fluid that is in a different chamber, a piston having opposing sides in pressure communication with different chambers and radially moveable with respect to an axis of the drill string in response to different pressures in the different chambers, and a steering arm on an outer surface of the drill string, the steering arm pivoting outward from the drill string into steering contact with a sidewall of the wellbore in response to radial movement of the piston. In an alternative, a rod is attached to the piston, the rod having a terminal end that projects radially outward from the drill string and is in sliding contact with an end of the steering arm with movement of the piston. In an alternative, the end of the steering arm is a first end, the steering arm having a second end opposite the first end that is pinned in a recess formed along an outer surface of the drill string. The system optionally includes valves upstream of the chambers, where selectively changing the valves between open, closed, and throttling configurations changes pressures in the chambers. In another alternative, the steering arm is a first steering arm, the steering system further includes a second steering arm coupled to an outer surface of the drill string and a rod coupled with the piston, the rod having opposing ends in contact with lateral sides of the first and second steering arms, optionally, strategically changing valves upstream of the chambers between open, closed, and throttling configurations changes pressures in the chambers to selectively move the piston towards the first steering arm or second steering arm. In an embodiment, a first recess is formed on the end of the rod and second recess that is complementary to the first recess is formed on a surface of the steering arm opposite the first recess, the steering system further including a ball having a first portion disposed in the first recess and a second portion disposed in the second recess. In an alternative to this embodiment, a first recess is formed on the end of the rod and second recess that is complementary to the first recess is formed on a surface of the steering arm opposite the first recess, the steering system further having a first ball disposed in the first recess and a second ball disposed in the second recess, and a journal disposed between the first and second balls and having third and fourth recesses on opposing surfaces that receive the first and second balls respectively.

Another example drilling system for excavating a wellbore is disclosed that includes a rotational drive unit, a drill string coupled with the rotational drive unit and that is rotatable in response to operation of the rotational drive unit. The drill string is made up of a pipe string of lengths of drill pipe connected to one another end to end and having an axial bore that selectively contains a flow of drilling fluid, a drill bit coupled to an end of the pipe string, and a steering system. The steering system includes chambers in a path of the flow of drilling fluid, the chambers configured to receive a portion of the flow of drilling fluid that is selectively at a pressure different from another portion of the flow of drilling fluid that is in a different chamber, a piston having opposing sides in pressure communication with different chambers, the piston radially moveable with respect to an axis of the drill string in response to different pressures in the different chambers, and a rod attached to the piston having a tip that is selectively biased into direct contact with sidewalls of the wellbore. The system of this example further includes a housing having an opening intersected by the rod, and wherein a diameter of the tip exceeds a diameter of the opening.

Examples of the disclosed steering system do not utilize a non-rotating sleeve and operate pistons/pads in a cyclic manner and once per revolution for creating curvatures. In one aspect, the mud hydraulic operated rotary steerable system operates piston/pad devices that selectively apply force against the borehole wall without a flow bypass. Operating the pad/piston of the mud hydraulic operated rotary steerable system without a non-rotating sleeve from the main mud flow and without a bypass device enables dynamic steering independent from bit pressure drop, bypass sizes, current mud flow rate and density. Not requiring a bypass for steering allows tolerating higher levels of lost circulation material (“LCM”) and debris within the drilling fluid and also removes the necessity of using a filter to protect bypass channels form particles to avoid plugging. In an embodiment, within the housing is an actuator assembly for controlling mud flow into at least first and second chambers by means of first and second valves. The first and second chambers are in fluid communication with and form part of the drill string and housing passageway and are part of a steering system. The first chamber is preferably parallel to and adjacent to the second chamber. The first and second chambers have an inlet end and an outlet end, respectively. The outlet end of each of the first and second chambers includes first and second restriction members with a restricted position in which fluid flow to the respective first and second chamber is restricted and an open position in which the fluid flow is unrestricted or less restricted. The first and second valves can either partially or fully block the flow of the fluid flow in the first and second chamber when in the restricted position, thus controlling flow and pressure inside the first and second chamber. In one embodiment, the full flow of drilling fluid is forced through the double chamber assembly continuously and the volume of flow is constant. It is to be understood that as one of the first and second valves approaches the restricted position, the fluid pressure and flow increase in the unrestricted channel.

The present invention takes advantage of operating piston pressures and relief from the main flow as opposed to bypass flow operated systems of prior art devices and is therefore not restricted in piston size and quantity, respectively flow towards piston(s) to charge and discharge with steering pressure. It is to be understood that the pistons of the disclosed embodiments can be charged and discharged rapidly and as opposed to prior art systems literally without lag, even at high rpm and large piston sizes. The proposed piston/pad design with one steering piston/pad on either side of the tool uses cyclic pressure pulses for steering with two times the rotary frequency. Each chamber and thus each piston is actuated periodically once a revolution for steering into a desired direction. The steering pressure may be altered from low to high values and is dependent on the position of the valve restricting flow. The needed steering pressure may be lower, for example, when the turn or change in direction is more gradual.

Prior art systems utilize mud hydraulic systems operating with a portion of the drilling mud flow while guiding the main portion of the flow towards the drill bit and bit nozzles. The pad and piston actuation system therefore operates with a smaller fraction (typically below 10%) of the mud flow and a bypass channel. A valve is operated to guide the drilling mud into cylinder and piston devices to actuate the pads/pistons against the borehole formation. After actuation the piston retracts and discharges the drilling mud into the annulus. Operating prior art mud hydraulic activated devices pose several challenges: The bypass flow requires filter screens to prevent larger debris and particles from entering the valve, cylinder, piston and discharge components; Filter, valve, flow channels and discharge components may get blocked by sediments, particles or LCM. Blocked and/or plugged hydraulics may cause inability to steer; Discharge through a relief channel and/or sealing gap can cause erosion; Discharge through the relief channel and/or sealing gap is enforced by activation of an opposite pad/piston which causes a reduction of steer force; The hydraulics depend on pre-selected (tool and bit) nozzles as well as flow rate and density of the mud flow, restricting operating parameters. This application discloses options to resolve or minimize the conflict of creating large steer force while keeping housing openings at a minimum diameter. Disclosed here are options to position the required steering piston into a central position of the housing, allowing the piston surface to be maximized without compromising strength of the housing. Comparably small rods and respective bushings through the tool housing are used to transfer the piston force to an external pad or directly to the borehole wall. Such rods are positioned on either side of the tool housing, 180° offset. In examples, rods are rigidly connected maximizing the support length for the piston arrangement with one rod on either side and equal to the housing diameter. The maximized support length of the piston arrangement allows for high side loads that typically pose design problems. Pistons operating at high side loads, such as from the sliding contact with the borehole wall or from the inclined force from a pivoting steering pad, require long guiding length. With prior art systems such guiding length is limited by the housing thickness, typically, considerably smaller than half the housing diameter. Therefore, the current disclosure teaches multiple solutions for problems, typically existing in rotary steerable drilling assemblies.

### BRIEF DESCRIPTION OF DRAWINGS

Some of the features and benefits of the present invention having been stated, others will become apparent as the description proceeds when taken in conjunction with the accompanying drawings, in which:

FIG. 1 is a side partial sectional view of an example drilling system forming a wellbore.

FIGS. 2A and 2B are side and axial sectional views of an example of a steering assembly for use with the drilling system of FIG. 1.

FIG. 3 is a side partial sectional view of an example of steering the drilling system of FIG. 1 with the steering assembly of FIGS. 2A and 2B.

FIGS. 4A and 4B are side and axial sectional views of an alternate example of a steering assembly for use with the drilling system of FIG. 1.

FIG. 5 is an axial sectional view of an alternate example of a steering assembly for use with the drilling system of FIG. 1.

FIGS. 6A-6C are axial sectional views of alternate examples of a steering assembly for use with the drilling system of FIG. 1.

FIG. 7 is a side partial sectional view of an example of a steering system having a valve assembly and the steering assembly of FIG. 6B.

FIG. 8 is an example of a valve system for use with the steering assemblies.

While subject matter is described in connection with embodiments disclosed herein, it will be understood that the scope of the present disclosure is not limited to any particular embodiment. Instead, the present disclosure is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

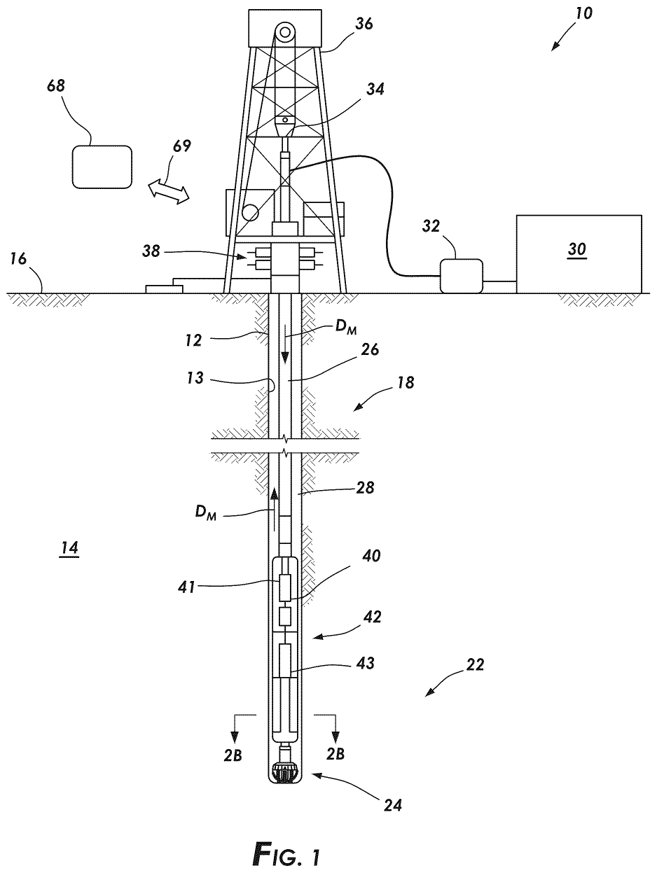

In FIG. 1 is a side partial sectional view of an example of using a drilling assembly 10 to form a wellbore 12 into a subterranean formation 14 from surface 16. Drilling assembly 10 includes a drill string 18 that is made up of a pipe string 20 and a bottom hole assembly (“BHA”) 22. The pipe string 20 is formed by connecting multiple joints of drill pipe end to end, and the BHA 22 is on a downhole end of pipe string 20, a drill bit 24 is on an end of drill string 18 disposed within the wellbore 12. In the example shown, drilling mud D_{M} flows within an inner bore 26 of the pipe string 20 to the drill bit 24 and exits bit 24 through nozzles (not shown) on the lower end of the bit 24. After exiting the bit 24, the drilling mud D_{M} flows back uphole within an annulus 28 between a sidewall 13 of the wellbore 12 and drill string 18. The drilling mud D_{M} is provided from a mud source 30, such as a mud pit, a suction tank, and/or shaker tank shown outside the wellbore 12 on surface 16. A line carries drilling mud D_{M} from an outlet of the mud source 30 to a pump 32 that pressurizes the drilling mud D_{M} and directs it through another line to a kelly 34 suspended within a derrick 36 assembled over an opening of wellbore 12. An upper end of drill string 28 connects to a lower end of kelly 34, beneath the kelly 34 the drill string 18 passes through a wellhead assembly 38 mounted on top of an opening of wellbore 12. The wellbore is also referred to herein as borehole.

In examples, the BHA 22 includes components to determine a downhole location of the BHA 22 and the drill bit 24 and to determine the properties of the rock formation 14 surrounding the wellbore 12, including detecting hydrocarbon bearing rock formation layers. The BHA 22 optionally includes a mud motor 40 for rotating the drill bit 24, and a steering system 42 to control the trajectory of the drill bit 24 along a path P (FIG. 3) so that wellbore 12 conforms to a designated configuration. Included with the steering system 42 is a steering assembly 43, which includes components that contact sidewall of the wellbore 12 for directing a trajectory of the BHA within the formation 14. Further auxiliary devices optionally included with the BHA 22 include one or more of the following: a formation evaluation device (FE device), such as a resistivity device, a nuclear resonance device, an acoustic device, a density device, or a formation sampling device, a measurement while drilling device (MWD) configured to detect inclination and azimuth of the borehole, an accelerometer, a magnetometer, a power source, such as a downhole generator or a battery, and a telemetry device to communicate with the surface. Examples of the telemetry device include a mud pulser, an electromagnetic telemetry device, or an acoustic telemetry device. In an alternative configuration the BHA 22 and drill string 18 include a wire (not shown) to the surface (wired pipe). The term uphole in this application refers to a direction or location within the wellbore 12 that is closer to the surface 16, and the term downhole refers to a direction or location within the wellbore 12 that is closer to a bottom end of the wellbore 12. An upstream direction or location is towards an approaching flow of drilling mud D_{M}, conversely, a downstream direction or location is towards a retreating flow of drilling mud D_{M}.

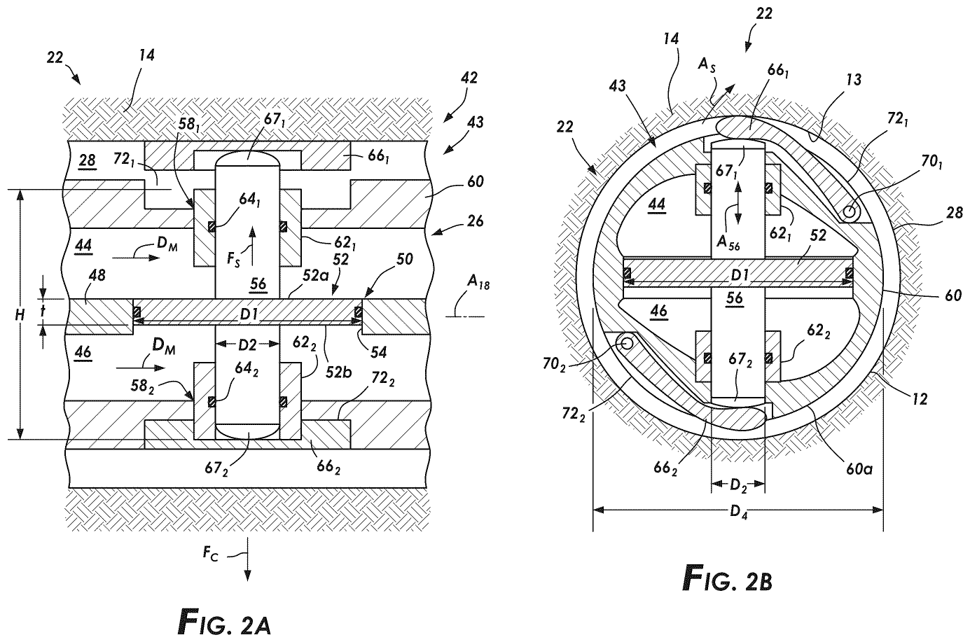

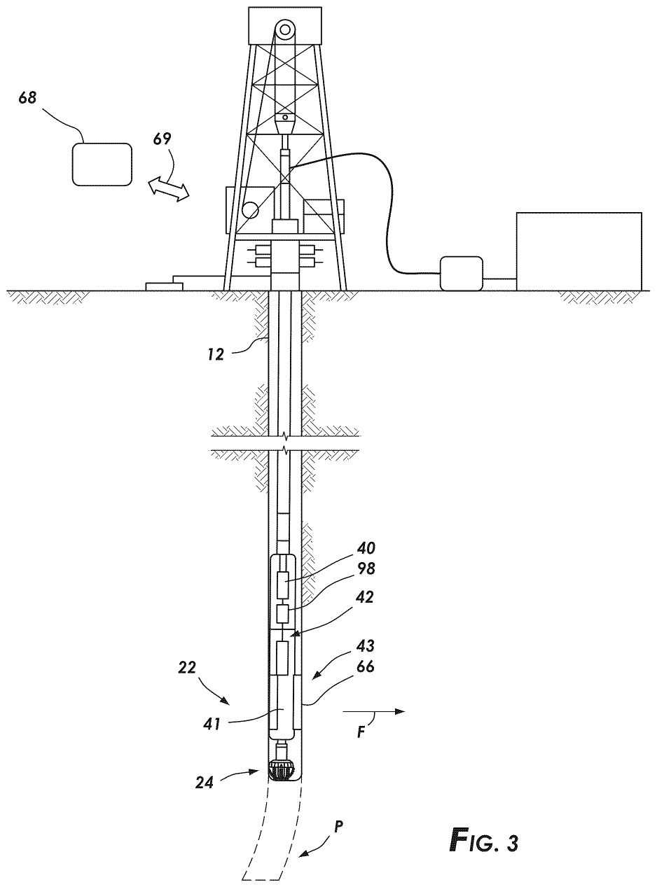

Shown in a side sectional view in FIG. 2A and axial sectional view in FIG. 2B is a portion of the drill string 18 having the steering assembly 43. In the example shown, the steering assembly 43 includes chambers 44, 46 (first chamber 44, second chamber 46) that are adjacent one another and each within the bore 26 of the pipe string 20. A wall 48 is shown between chambers 44, 46 and extending generally parallel with an axis A₁₈ of the drill string 18. An opening 50 is formed radially through a portion of wall 48, and a piston 52 is disposed within opening 50. A seal 54, such as an O-ring seal, circumscribes piston 52 along the interface between wall 48 and piston 52. A combination of wall 48, piston 52, and seal 54 defines a fluid flow barrier between chamber 44 and chamber 46. In examples, the opening 50 functions as a cylinder, so that piston 52 is radially movable within opening 50. As described in more detail below, piston 52 is movable in response to a pressure differential between chambers 44, 46. The pressure differential is a fluid pressure differential caused by different fluid pressures in the first chamber 44 and the second chamber 46. The example steering assembly 43 further includes elongated rod 56 shown coupled with piston 52 and extending in a direction radial to axis A₁₈. Ends of rod 56 distal from piston 52 projects radially through apertures 58_{1, 2} formed in a housing 60 of the BHA 22. Annular collars 62_{1, 2} insert into apertures 58_{1, 2} and operate as bushings between the rod 56 and apertures 58_{1, 2}. Seals 64_{1, 2}circumscribe portions of rod 56 disposed within collars 62_{1, 2} to form fluid flow barriers between the rod 56 and collars 62_{1, 2}. It shall be understood that seals 64_{1, 2}, 54 can have different shapes, materials, function principles, etc., and in alternatives can be designed as gap seals, forming a barrier between two chambers by means of a narrow gap. Seals can either be fluid tight or lossy through a leakage gap. Further alternatively, seals can be formed with hermetic barriers, such as rubber or metal bellows. In alternatives, the size of the gap of seals 54, 64_{1, 2} is selected to maintain a seal at various magnitudes of the differential pressure, allowing some minor portion of the fluid to cross the seal gap 54, 64_{1, 2} and to leak into the respective next chamber, e. g. across the seal 64_{1, 2} from chamber 44, 46 into the annulus 28 or between chambers 44, 46 and across seal 54. Example gap sizes for seals 54, 64_{1, 2} are within a range of 10 μm to 100 μm. When very small leakage is required or the differential pressure is high, the gap of seals 54, 64₁₂ can also be smaller, such as within a range of 1 μm to 10 μm. When leakage does not play a major role and pressure differential is comparably low, typical gap sizes for seals 54, 64_{1, 2} can range from 100 μm to 1000 μm. In order to maintain the integrity of the seals 54, 641, 2 over a long duration of operation, the material of the rod 56, the annular collars 62_{1, 2}, the opening or cylinder 50, and the piston 52 can be selected from a hard material, such as but not limited to, tungsten carbide, a technical ceramic (such as Silicon Carbide, Silicon Nitride, Boron Nitride, etc.), Polycrystalline Diamond, or other suitable wear resistant materials (either as a solid material or as a coating). The axis A₁₈ is a longitudinal axis of the drill string. A radial direction or orientation in this application refers to a direction perpendicular to the longitudinal axis A₁₈ of the drill string 18. The piston 52 has a first side 52a and a second side 52b on radially opposing ends of the piston 52. The first side 52a is in fluid communication with the first chamber 44, and the second side 52b is in fluid communication with the second chamber 52.

Mounted to the outer surface of housing 60 are steering arms 66_{1, 2}, radially inward facing surfaces of free ends of steering arms 66_{1, 2} are in contact with tips 67_{1, 2} that are on the ends of rod 56. As illustrated, the surfaces of tips 67_{1, 2} in contact with arms 66_{1, 2} are convexly curved to enhance sliding between tips 67_{1, 2} and arms 66_{1, 2}. As shown in FIG. 2B arms 66_{1, 2} have elongate lengths extending along respective portions of the circumference of housing 60. Pinned ends of arms 66_{1, 2} are distal from their free ends that are in contact with tips 67_{1, 2}, the pinned ends are hinged to the housing 60 by pins 70_{1, 2} that allow pivoting movement of the arm 66_{1, 2} as schematically illustrated by arrow As. Recesses 72_{1,2} are formed along portions of the outer surface of housing 60 and form receptacles in which the arms 66_{1, 2} selectively retract to avoid contact with the wall of the wellbore 12.

Referring back to FIG. 1, a controller 68 is shown on surface, which is in communication with the drill string 18 via communication means 69. Examples of communication mean 69 include hardwired, fiber optics, and wireless (such as a mud pulse). In a non-limiting example of operation, signals generated by controller 68, or provided to controller 68 by a wellbore operator, are transmitted to the drill string 18 via communication means 69. Embedded in the signals are instructions for controlling the drilling direction. Such instructions selectively adjusts pressure in chambers 44, 46 (FIGS. 2A and 2B) so that a pressure differential is generated across piston 52 that urges piston 52 and rod 56 in a radial direction and bias one of tips 67_{1, 2} into contact with the inner radial surface of one of the steering arms 66_{1, 2}. Arrow A₅₆ of FIG. 2B illustrates selective movement of rod 56 towards either one of arms 66_{1, 2}. In the example of FIGS. 2A and 2B, the step of pressure control causes pressure in chamber 46 to exceed pressure in chamber 44 and generate a force that is exerted against piston 52 moving piston and rod 56 in a radial direction that impinges tip 67₁ against the inner radial surface of free end of arm 66₁ causing arm 66₁ to pivot radially outward against and into steering contact with the sidewall 13 of wellbore 12, which transfers a steering force F_{S} from the arm 66₁ to the sidewall of the wellbore 12. In a non-limiting example, the steering force F_{S} is transferred to the sidewall 13 of the wellbore 12 in a timed manner and engaging with the sidewall at a controlled direction while the pipe string 20 and the bottom hole assembly BHA 22 are rotating. Thus, for each revolution of the BHA 22 and steering system 42 during a drilling deviation, the piston 52 can be extended and retracted one time during each revolution of the steering system 42.

For the purposes of discussion herein, when one of arms 66_{1, 2} is in steering contact with the sidewall 13 of the wellbore 12, the steering force F_{S} generates a counterforce F_{C} that is exerted against the BHA 22 and bit 24 to steer the bit 24 within the formation 14. To control drilling into an azimuthal direction, relative pressures in chambers 44, 46 are adjusted to urge rod 56 with a momentarily required force F_{S} to control drilling into an opposite direction pushing the bit 24 with a momentary force F_{C}. By strategically timing the generation and duration of the counterforce F_{C}, the wellbore 12 being formed with the drilling system 10 (FIG. 1) can have a configuration that substantially conforms with a designated configuration. In an example, a designated configuration of a wellbore is a configuration (e.g., shape, orientation, dimensions, coordinates, etc.) that is per design or as planned. Optionally, a gyroscope (not shown) is included in the BHA 22 to provide locational and orientation information about the orientation of the bit 24 to provide guidance for steering the bit 24 in an azimuthal direction that forms the wellbore 12 in a designated configuration. The rod 56 of FIGS. 2A and 2B is strategically dimensioned so that when one of arms 66_{1, 2}. is in steering contact or otherwise moved out of its respective recess 72_{1,2} the other one of the arms 66_{1, 2} is within its recess 72_{1, 2} towards the free end of arm 66₁, onto steering arm 66, that in turn pivots outward into contact with a side wall of well bore 12 to urge the bottom hole assembly 22 in an opposite direction. Strategically timing the pressure differential created across piston 52 as described above, and thereby outwardly pivoting one of the steering arms 66_{1, 2} to apply the steering force F_{S}, steers the drill bit 24 and along a path P (FIG. 3) to form the wellbore 12 in a designated configuration and/or orientation. One example means for controlling the pressures within chambers 44, 46 is a valving system (not shown) disposed upstream of chambers 44, 46, which selectively diverts a designated amount of drilling mud D_{M} into one of chambers 44, 46 to create a pressure imbalance between the two chambers 44, 46. An example of such a valving system is described in U.S. application Ser. No. 63/728,551.

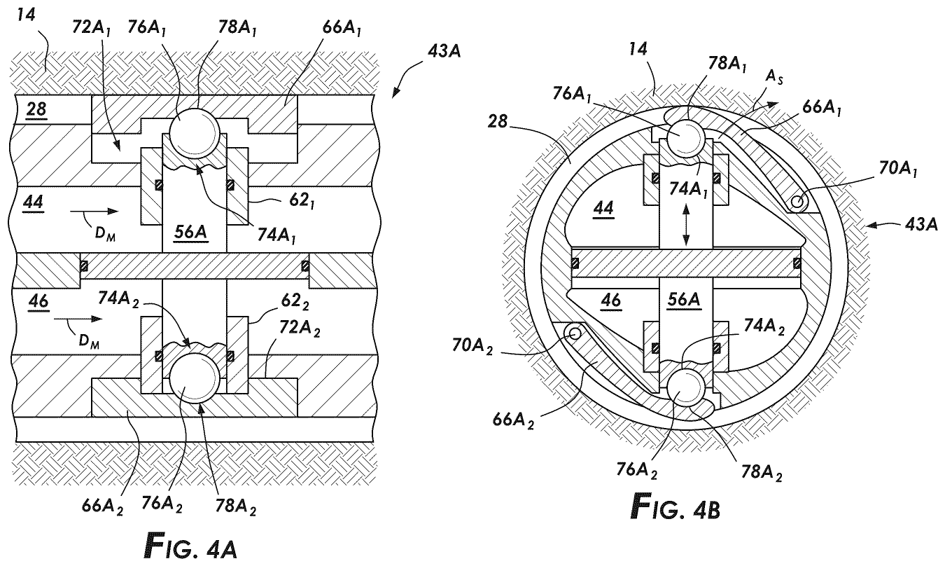

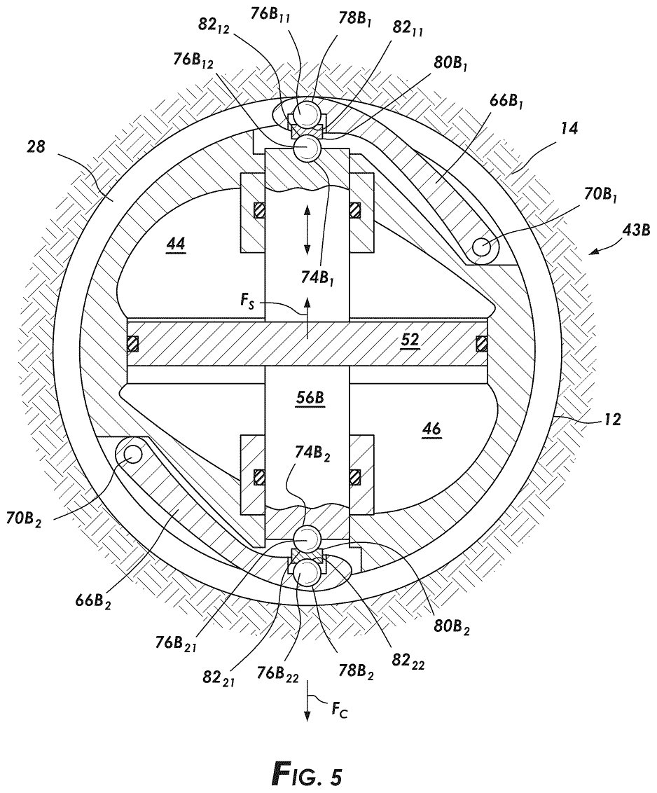

An alternate example of a steering assembly 43A is shown in sectional views in FIGS. 4A and 4B. Semi-spherical recesses, 74A_{1, 2} are shown formed on terminal ends of rods 56A_{1, 2}, balls 76A_{1, 2} are shown respectively within each of the recesses 74A_{1, 2}. Similar recesses are shown formed into radially inward lateral surfaces of arms 66A_{1, 2}. Recesses 78A_{1, 2} are complementary to recesses 74A_{1, 2} to receive opposing ends of balls 76A_{1, 2}. An advantage of the assembly of FIGS. 4A and 4B is that when rod 56A is urged radially outward to cause one of arms 66A_{1, 2} to pivot radially outward about its pinned end is that the friction between balls 76A_{1, 2} and receptacles 74A_{1, 2}, 78A_{1, 2} when urging one of the steering arms 66A_{1, 2} into steering contact is less than that between tips 67_{1, 2} and lateral surfaces of arms 66_{1, 2} of FIG. 2B. An end of arm 66A₁ is shown moved radially outward from recess 72A₁ and end of arm 66A₂ is shown inserted into recess 72A₂, which avoids contact with sidewall of wellbore 12. In order to allow the motion between components, radii of recesses 74A_{1, 2} and/or recesses 78A_{1, 2} is slightly larger than the radius of balls 76A_{1, 2}. The larger radius on one or more of the recesses 74A_{1, 2} and/or recesses 78A_{1, 2} causes a point contact between ball 76A_{1, 2} and recesses 74A_{1, 2} and/or recesses 78A_{1, 2}. Alternatively, instead of (semi-)spherical recesses, such recesses 74A_{1, 2} and/or recesses 78A_{1,2} can be formed as races in the plane as shown in FIG. 4B, to enable the balls 76A_{1, 2} to roll and rotate with respect to the recesses 74A_{1, 2} and/or recesses 78A_{1, 2} when the arms 66A_{1, 2}, balls 76A_{1, 2} and receptacles 74A_{1, 2}, 78A_{1, 2} are deployed. In this example, the race would create a line contact between the three mating members and reduce side load at the rod 56A.

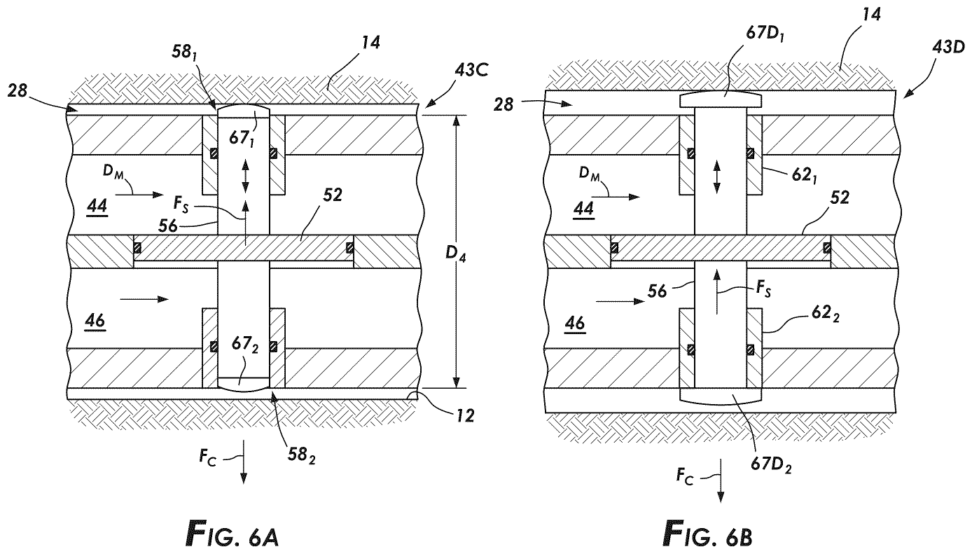

Another alternate embodiment of the steering assembly 43B is shown in an axial sectional view in FIG. 5. In this example, force F_{S} is transferred from rod 56B to arms 66B_{1, 2} by a multi ball and receptacle arrangement. In this example, between rod 56B and arm 66B₁ is a first ball 76B₁₂ which is in receptacle 74B₁₂, and a second ball 76B₁₁ shown disposed within receptacle, 78B₁ formed on the radially inward side of the free end of arm 66B₁. Between the first and second balls 76B₁₂, 76B₁₁ is a journal (or connecting rod) 80B₁. A receptacle 82₁₂ is formed on a surface of journal (or connecting rod) 80B₁ facing ball 76B₁₂, which receives ball 76B₁₂ within. Similarly, on a radially outward surface of journal (or connecting rod) 80B₁ facing ball 76B₁₁ is a receptacle 82₁₁ formed complementary to ball 76B₁₁. In this example, motion is possible, even if all radii of balls 76B₁₂, 76B₁₁, journal, or connecting rod and receptacles 74B₁₂, 78B₁, 82₁₁, 82₁₂ are equal. Identical radii of balls and receptables distribute the load over a surface area as opposed to point or line contacts of previous embodiments. Friction between rod 56B and arm 66B₁ is further reduced by the multiple ball and receptacle arrangements. The interface between rod 56B steering arm 66B₂ also includes first and second balls 76B₂₁, 76B₂₂ and a journal (or connecting rod) 80B₂ between the balls 76B₂₁, 76B₂₂. Journal (or connecting rod) 80B₂ is fitted with a receptacle 82₂₁ on its radial inward side to receive an outer radial portion of ball 76B₂₁, and on an opposite side of journal (or connecting rod) 80B₂ is a receptacle 82₂₂ that receives a radially inward portion of ball 76B₂₂, a receptacle 78B₂ receives a radially outward portion of ball 76B₂₂. With such arrangement, side loads at the rod 56B and the arm 66B₁₂ can be further reduced. The embodiments of FIGS. 4 and 5 operate in substantially the same way as that of FIG. 2, i.e., selectively controlling a pressure of drilling mud D_{M} flowing through the chambers 44, 46 creates a pressure differential across the piston 52 to drive the piston 52 in a radial direction to exert steering force F_{S} against sidewall 13 of wellbore 12 to generate a counterforce F_{C} for steering the drill bit 24 through formation 14 along a designated path P (FIG. 3) so that the wellbore 12 has a designated configuration. In one embodiment the balls 76B₁₂/76B₂₁ can be integrally formed with rods 56B and/or the balls 76B₁₁/76B₂₂ can be integrally formed with arms 66B₁/66B₂.

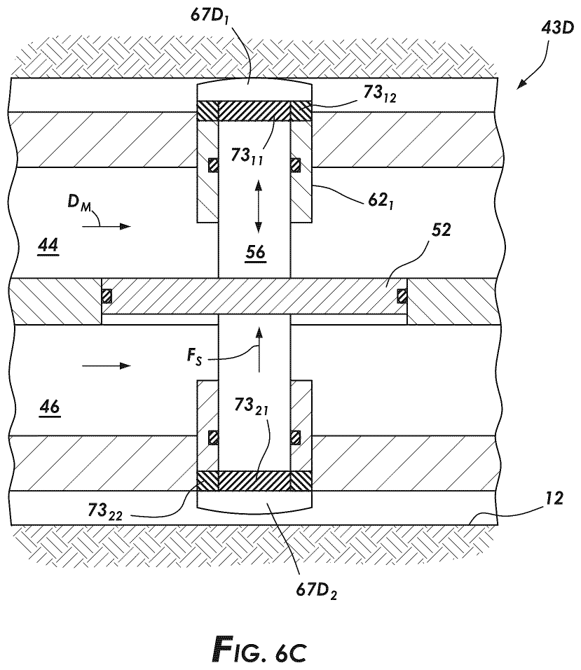

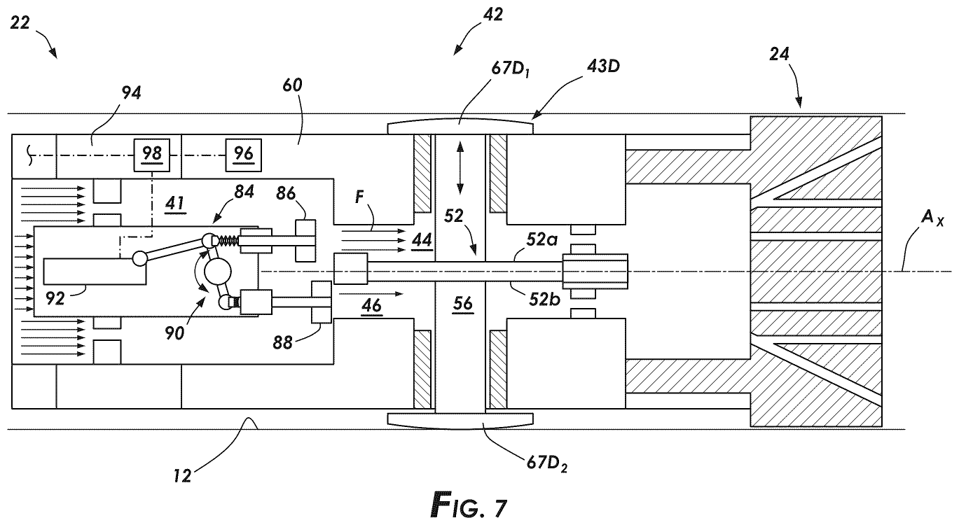

Shown in side sectional views in FIGS. 6A and 6B are alternate examples of steering assemblies 43C and 43D that do not include a steering arm. The steering assembly 43C of FIG. 6A, operates similar to steering assembly 43 of FIG. 2A, i.e., a pressure imbalance is created between chambers 44 and 46, which when applied to piston 52 generates a steering force F_{C} that is exerted by rod 56. The force F_{S} moves rod 56 radially through aperture 58₁ and collar 62₁ opposite the direction of steering force Fs. In the embodiment of FIG. 6A the paths across the annulus 28 between each of the apertures 58_{1, 2} and the sidewall 13 of the wellbore 12 are unobstructed, and by exerting the steering force F_{C} onto the rod 56 in the direction as shown, the tip 67₁ is urged into direct contact with the sidewall 13 of the wellbore 12. Conversely, creating a pressure differential that reverses the direction of the steering force F_{C} urges tip 67₂ into contact with the sidewall 13 of the wellbore 12 and/or surrounding formation 14. In the example of FIG. 6B, the steering assembly 43D operates similar to that of steering assembly 43C of FIG. 6A. One difference between the assemblies 43C, 43D is that diameters of tips 67D_{1, 2} exceeds inner diameters of collars 62_{1, 2} and limits radial travel of tips 67D_{1, 2} radially inward past their respective collars 62_{1, 2}. In an alternative, diameters of tips 67D_{1, 2} exceed diameters of apertures 58_{1, 2}, so that in a further alternative that does not include collars, radial travel of rod 56 is limited by interference between tips 67D_{1, 2} and apertures 58_{1, 2}.

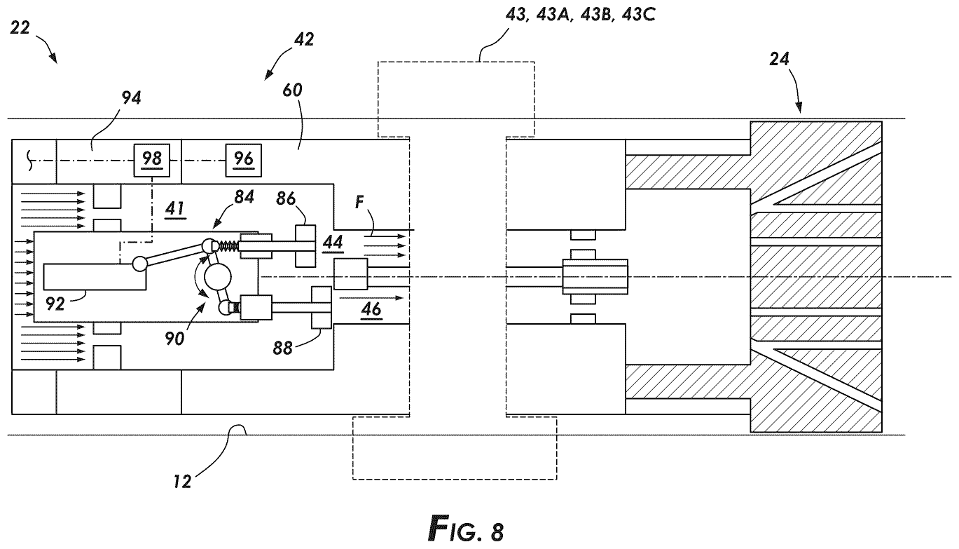

As can be seen in FIGS. 2-6 , the piston arrangement formed from the rods 56 on either side of the piston 52 spans across the entire diameter of the housing 60 enabling maximum guidance length H for the piston arrangement, and allowing a comparably short thickness t of piston 52 sliding in the opening or cylinder 50, which would need to be significantly more if the rods 56 were not utilized as guiding parts. Such long guiding length H is especially of advantage when designing the steering unit according to FIGS. 6A and 6B where the tips 67_{1, 2} that are on the ends of rod 56 are in direct sliding contact with the borehole wall during operation. An example size for the guiding length H is around 90% of the housing outer diameter DH. In alternatives, the guiding length H is about 100% of the housing outer diameter DH or about 50% of the housing outer diameter DH. An example size for the piston thickness t is about 10%-20% of the housing outer diameter DH. In alternatives the piston thickness t is about 5% of the housing outer diameter DH thickness t or more than 20% of the housing outer diameter DH. As can be seen in FIG. 2B, FIG. 4B, and FIG. 5, the size or diameter D1 of the piston 52 can be selected to have a maximum diameter D1 because of its placement near the center or central axis of the housing 60, the central axis is a rotational axis of the housing and parallel to the longitudinal axis A₁₈. The central axis is in the center of a rotary connection 24a (FIG. 7) to the drill bit. As explained above, the piston 52 reacts on differential pressure between chambers 44, 46. For those skilled in the art, it is known that the comparably large diameter D1 of the piston 52 allows the differential pressure between chambers 44, 46 to remain on a lower level for a given and required steering force (steering force is proportional to the differential pressure between chambers 44, 46 and the effective surface area of the piston 52, first effective surface area on the first side 52a, second effective surface area on the second side 52b of the piston 52). For the same reason, maximizing the diameter D1 of piston 52, the diameters D2 of the rods are kept small. An size for the piston diameter D1 is about 70% of the housing outer diameter DH. In alternatives, the piston diameter D1 is about 90% of the housing outer diameter DH or about 35% of the housing outer diameter DH. An example size for the rod diameter D2 is about 25% of the piston diameter D1. In alternatives, the rod diameter D2 is about 10% of the piston diameter D1 or more than 50% of the piston diameter D1. As can be seen also in FIG. 2-F IG. 6, rods can be designed at a comparably small diameter, enabling design options with smaller openings through the sidewall 60a of the housing 60. Smaller opening through the sidewall 60a of the housing 60 reduces mechanical stresses at the expected load scenario from downhole drilling. As a general rule, the smaller such openings, the better in terms of stresses and in the proposed design concept also in terms of steering force. Shown in FIG. 6C is an alternative embodiment of steering assembly 43D that includes optional spring elements 73₁₁, 73₁₂ between opposing ends of rod 56 and tips 67D_{1,2} and spring elements 73₂₁, 73₁₂ between tips 67D_{1,2} and outer radial ends of collars 62_{1, 2}. In examples, spring elements 73₁₁₋₂₂ are formed from elastic material (metals, polymeric, etc.) and exert a biasing force when in compression. As shown, spring elements 73₁₁₋₂₂ urge the tips 67D_{1, 2} radially outward for maintaining contact between tips 67D_{1,2} and sidewall 13 of the wellbore 12. Embodiments exist in which spring elements 73₁₁₋₂₂ are pretensioned so that tips 67D_{1, 2} are constantly pressed against the sidewall 13 of the wellbore 12. In a non-limiting example of operation, during steering the piston 52 moves back along its axis of movement compressing spring elements 73_{11, 12} while partially releasing spring elements 73_{21, 22}. Spring elements 73₁₁₋₂₂ ease the interaction between tips 67D_{1,2} and sidewall of the wellbore 12 to create a smoother force transition. For example, with the spring elements 73_{11, 12}, both tips 67D_{1,2} remain in contact with the sidewall 13, so that an impact impulse with the sidewall is avoided when the direction of steering force F_{S} reverses and the steering force F_{S} is applied to the opposing tip.

Shown in side sectional view in FIG. 7 is a valve assembly 84 included with the steering system 42 disposed in the fluid passageway 41 of the BHA 22, and in the path of drilling fluid F flowing towards the drill bit 24. The drilling fluid F flows through housing 60 and along fluid passageway 41. The valve assembly 84 controls drilling fluid F flow into chambers 44 and 46 with poppets 86, 88 that selectively reciprocate adjacent to and upstream of inlets to the chambers 44, 46. The poppets 86, 88 are mounted on an articulated linkage assembly 90 that is driven by an actuator 92. A communication means 94, examples of which include wireless, wired, and fiber optic, provides communication between actuator 92 and the controller 68 (FIG. 1) on surface 16. In an example, commands from surface 16 control operation of actuator 92 to operate linkage 90 so that poppets 86, 88 interfere with and control the amount of drilling fluid F flowing into chambers 44, 46. By strategically regulating the amount of drilling fluid F flowing into the respective chambers 44, 46, a pressure difference is generated across the piston 52, which as described above, biases one of tips 67D_{1,2} into steering contact with the sidewall 13 of the wellbore 12 to urge bit 24 in an opposite direction and steer BHA 22 along the designated path P (FIG. 3). Included in the BHA 22 is a sensor 96 that measures the current toolface of the rotation of the bit 24. Sensor 96 optionally determines the inclination and direction of the steering system 42 and can be located in various locations in the drill string 20 or BHA 22. Also included in the example of FIG. 6C is a controller 98, which is in communication with actuator 92, sensor, and controller 68 via communication means 94. Based on an output from the sensor 96, the controller 98 (or controller 68) determines a steering direction and steering force during rotation. Corresponding signals are sent to the actuator 92, which selectively reciprocates poppets 86, 88 for controlling the flow of drilling fluid F in the passageway 41 into chambers 44, 46. As described above, strategically controlling the flow of fluid F into chambers 44, 46 biases piston 52 in a designated direction and at a designated force so that the BHA 22 is directed in the determined steering direction and with the determined steering force. In this example, for each revolution of the BHA 22 and steering assembly 43 during a drilling deviation, the piston 52 is extended and retracted one time during each revolution of the steering assembly 43. The controller 98 optionally receives inclination and azimuth information from sensor 96. Sensor 96, or additional sensors (not shown), are optionally disposed outside of controller 98 and located in various locations in the drill string 20 or BHA 22. Controller 96 optionally receives and transmits information from and to the surface 16 (FIG. 1).

Referring now to FIG. 8, shown in a side partial sectional view is an example of valve assembly 84 included in the BHA 22, and illustrating that valve assembly 84 is also combinable with steering assemblies 43, 43A-C. Similar to the operation described above, selectively energizing actuator 92 affects pressures in chambers 44, 46 for controlling operating of steering assemblies 43, 43A-C.

### EMBODIMENTS

### Embodiment 1

A method of wellbore operations comprising:
forming a wellbore in a subterranean formation with a drill string that comprises a drill bit on an end of a pipe string;
directing a flow of drilling fluid through a bore in the pipe string;
splitting the flow into first and second streams having different pressures;
selectively converting the different pressures into a force; and
steering the drill bit through the formation by applying the force between the drill bit and a sidewall of the wellbore.

### Embodiment 2

The method of Embodiment 1, wherein the first stream is directed into a first chamber and the second stream is directed into a second chamber, wherein a fluid flow barrier is between the first and second chambers that comprises a piston moveably disposed in a cylinder, and wherein the piston moves radially with respect to an axis of the drill string in a direction away from the stream having the greater pressure.

### Embodiment 3

The method of claim 2, wherein the force is exerted to the sidewall by a steering arm that is on an outer surface of the drill string, the steering arm pivoting outward from the drill string into steering contact with a sidewall of the wellbore in response to radial movement of the piston.

### Embodiment 4

The method of Embodiment 3, wherein the steering arm has a pinned end pivotingly coupled to the drill string, a free end distal from the pinned end, and extends along a portion of a circumference of the drill string between the free end and the pinned end.

### Embodiment 5

The method of Embodiment 4, wherein the force is transferred from the piston to the steering arm by a rod, the rod having a terminal end in sliding contact with a lateral surface of the free end that faces an outer surface of the drill string.

### Embodiment 6

The method of Embodiment 5, wherein a valve system is used to split the flow into first and second streams and at different pressures.

### Embodiment 7

The method of Embodiment 6, wherein the steering arm comprises a first steering arm, wherein the valve system, piston, rod, and first steering arm comprise a steering system, wherein the steering system further comprises a second steering arm, and wherein the second steering arm has a pinned end pivotingly coupled to the drill string, a free end distal from the pinned end, and extends along a portion of a circumference of the drill string between the free end and the pinned end.

### Embodiment 8

The method of Embodiment 7, further comprising steering the drill bit in a different direction by reversing relative pressures in the streams so that the second steering arm is pivoted radially outward from the drill string.

### Embodiment 9

The method of Embodiment 5, further comprising forming complementary curved contact surfaces between the rod and the steering arms to reduce friction between the rod and the steering arms.

### Embodiment 10

A drilling system for excavating a wellbore comprising:
a rotational drive unit;
a drill string coupled with the rotational drive unit and that is rotatable in response to operation of the rotational drive unit, the drill string comprising;
a pipe string comprising lengths of drill pipe connected to one another end to end and having an axial bore that selectively contains a flow of drilling fluid,
a drill bit coupled to an end of the pipe string, and
a steering system comprising,
chambers in a path of the flow of drilling fluid, the chambers configured to receive a portion of the flow of drilling fluid that is selectively at a pressure different from another portion of the flow of drilling fluid that is in a different chamber,
a piston having opposing sides in pressure communication with different chambers, the piston radially moveable with respect to an axis of the drill string in response to different pressures in the different chambers, and
a steering arm on an outer surface of the drill string, the steering arm pivoting outward from the drill string into steering contact with a sidewall of the wellbore in response to radial movement of the piston.

### Embodiment 11

The system of Embodiment 10, wherein a rod is attached to the piston, the rod having a terminal end that projects radially outward from the drill string and is in sliding contact with an end of the steering arm with movement of the piston.

### Embodiment 12

The system of Embodiment 11, wherein the end of the steering arm comprises a first end, the steering arm having a second end opposite the first end that is pinned in a recess formed along an outer surface of the drill string.

### Embodiment 13

The system of Embodiment 10, further comprising valves upstream of the chambers, wherein selectively changing the valves between open, closed, and throttling configurations changes pressures in the chambers.

### Embodiment 14

The system of Embodiment 10, wherein the steering arm comprises a first steering arm, the steering system further comprising a second steering arm coupled to an outer surface of the drill string and a rod coupled with the piston, the rod having opposing ends in contact with lateral sides of the first and second steering arms.

### Embodiment 15

The system of Embodiment 14, wherein strategically changing valves upstream of the chambers between open, closed, and throttling configurations changes pressures in the chambers to selectively move the piston towards the first steering arm or second steering arm.

### Embodiment 16

The system of Embodiment 11, wherein a first recess is formed on the end of the rod and second recess that is complementary to the first recess is formed on a surface of the steering arm opposite the first recess, the steering system further comprising a ball having a first portion disposed in the first recess and a second portion disposed in the second recess.

### Embodiment 17

The system of Embodiment 16, wherein a first recess is formed on the end of the rod and second recess that is complementary to the first recess is formed on a surface of the steering arm opposite the first recess, the steering system further comprising a first ball disposed in the first recess and a second ball disposed in the second recess, and a journal disposed between the first and second balls and having third and fourth recesses on opposing surfaces that receive the first and second balls respectively.

### Embodiment 18

A drilling system for excavating a wellbore comprising:
a rotational drive unit;
a drill string coupled with the rotational drive unit and that is rotatable in response to operation of the rotational drive unit, the drill string comprising;
a pipe string comprising lengths of drill pipe connected to one another end to end and having an axial bore that selectively contains a flow of drilling fluid,
a drill bit coupled to an end of the pipe string, and
a steering system comprising,
chambers in a path of the flow of drilling fluid, the chambers configured to receive a portion of the flow of drilling fluid that is selectively at a pressure different from another portion of the flow of drilling fluid that is in a different chamber,
a piston having opposing sides in pressure communication with different chambers, the piston radially moveable with respect to an axis of the drill string in response to different pressures in the different chambers, and
a rod attached to the piston having a tip that is selectively biased into direct contact with sidewalls of the wellbore.

### Embodiment 19

The system of Embodiment 18, wherein the steering system comprises a housing having an opening intersected by the rod, and wherein a diameter of the tip exceeds a diameter of the opening.

The present invention described herein, therefore, is well adapted to carry out the objectives and attain the ends and advantages mentioned, as well as others inherent therein. While one or more embodiments have been given for purposes of disclosure, numerous changes exist in the details of procedures for accomplishing the desired results. These are intended to be encompassed within the spirit of the present invention disclosed herein and the scope of the appended claims.

What is claimed is:

1. A rotary steerable drilling system for drilling a wellbore into the earth's surface, the rotary steerable drilling system comprising:
a housing configured to be mechanically connected to a drill bit and a drill string;
a fluid passageway in the housing configured to guide a flow of a drilling fluid from the drill string to the drill bit;
a first and second chamber in the fluid passageway,
a valve disposed in the fluid passageway,
the valve configured to temporarily increase a fluid pressure in the first chamber relative to the fluid pressure in the second chamber,
a piston having opposing sides in fluid pressure communication with the first chamber and the second chamber, the piston radially moveable with respect to a longitudinal axis of the drill string in response to different fluid pressures in the first chamber and the second chamber, and
a rod configured to transfer motion through the housing to provide a steering force with a wall of the wellbore in response to radial movement of the piston.

2. The system of claim 1, wherein the rod has a terminal end that projects radially outward from the drill string and is in sliding contact with the sidewall of the wellbore.

3. The system of claim 1, wherein the valve is upstream of the first and second chambers, the valve selectively changing between open, closed, and throttling configurations to change fluid pressures in the first and second chambers.

4. The system of claim 1, wherein a steering arm is disposed on an outer surface of the housing, the steering arm being in contact with the rod, the steering arm pivoting outward from the drill string into steering contact with a sidewall of the wellbore in response to the radial movement of the piston.

5. The system of claim 1, wherein the rod is connected to the steering arm through a connecting rod.

6. The system of claim 5, wherein the connecting rod makes surface contact with the rod and the steering arm.

7. The system of claim 4, wherein the rod makes line contact with the arm, either directly or via a member.

8. The system of claim 7, wherein the member rotates upon radial movement of the piston.

9. The system of claim 1, wherein the housing has a central axis defined by the rotary connection to the drill bit and wherein the piston is located proximate the central axis and wherein the piston intersects the central axis when radially moving.

10. The system of claim 1, wherein the housing has a diameter, and the piston has a diameter larger than 50% of the largest diameter of the housing.

11. The system of claim 1, wherein the piston has a diameter, and the rod has a diameter of less than 50% of the piston diameter.

12. A method of steering a drilling system while forming a wellbore into a subterranean formation, the method comprising:
the drilling system comprising a drill string, a drill bit on an end of the drill string, a housing connected to the drill bit, a fluid passageway in the housing, first and second chambers in the fluid passageway, a piston between the first and second chambers, a rod extending radially from the piston, and a valve in the fluid passageway;
directing a flow of drilling fluid through a bore in the drill string; and
using the valve to temporarily raise fluid pressure in the first chamber above fluid pressure in the second chamber and urge the piston radially into the second chamber so that the rod projects radially outward from the drill string and exerts a force against a sidewall of the wellbore to steer the drill bit through the subterranean formation.

13. The method of claim 12, wherein a terminal end of the rod is in sliding contact with the sidewall of the wellbore.

14. The method of claim 12, wherein the valve is upstream of the first and second chambers, the valve selectively changing between open, closed, and throttling configurations to change fluid pressures in the first and second chambers.

15. The method of claim 12, wherein a steering arm is pivotably mounted onto the housing and has a free end with a radially inward facing surface that is impinged by a terminal end of the rod so that a radially outward facing surface of the steering arm is biased into contact with the sidewall of the wellbore.

16. The method of claim 15, further comprising reducing friction between the rod and the steering arm by forming hemispherical recesses on opposing surfaces of the rod and steering arm, wherein the recesses are complementary to one another, and disposing a ball in the recesses so that the ball rotates with respect to the recesses as the rod extends radially outward.

17. The method of claim 15, further comprising reducing friction between the rod and the steering arm by forming first and second hemispherical recesses on opposing surfaces of the rod and steering arm, providing a journal having third and fourth hemispherical recesses on opposing surfaces, positioning the journal between the rod and steering arm so that the first and third hemispherical recesses are facing each other and complementary to one another and so that the second and fourth hemispherical recesses are facing each other and complementary to one another, and disposing a first ball in the first and third recesses and a second ball in the second and fourth recesses, so that the balls rotates with respect to the recesses as the rod extends radially outward.

18. The method of claim 12, further comprising using the valve to temporarily raise pressure in the second chamber above pressure in the first chamber and urge the piston radially into the first chamber.

19. The method of claim 12, wherein the rod comprises a first rod, wherein the force comprises a first force, and wherein a second rod projects radially in a direction different from the first rod and exerts a second force against a sidewall of the wellbore that is in a direction different from the first force.

20. The method of claim 19, wherein the first force generates a first steering force, and the second force generates a second steering force, and wherein first and second steering forces are in different directions.
